(19) United States
(12) Patent Application Publication
(10) Pub. No.: US 2023/0067072 A1
(43) Pub. Date: Mar. 2, 2023

(54) OPTICAL ACTUATOR, CAMERA MODULE, AND CAMERA-MOUNTED DEVICE

(71) Applicants: Ichiro HAYASHI, Tokyo (JP); Yoshihiro KIMURA, Tokyo (JP)

(72) Inventors: Ichiro HAYASHI, Tokyo (JP); Yoshihiro KIMURA, Tokyo (JP)

(73) Assignee: Mitsumi Electric Co., Ltd., Tokyo (JP)

(21) Appl. No.: 17/895,113

(22) Filed: Aug. 25, 2022

(30) Foreign Application Priority Data
Aug. 30, 2021 (JP) 2021-139954

(51) Int. Cl. G03B 5/08; H02K 41/035; G03B 13/36

(52) U.S. Cl. CPC G03B 5/08; H02K 41/0354; G03B 13/36; G03B 2205/0069

(57) ABSTRACT

An optical actuator is configured to include: a movable part including a mounting surface for an optical path bending member, and a recessed portion extending toward a center of the mounting surface at a back side of the mounting surface, the movable part being swung by driving of a driving part; and a fixing part including a protruding portion inserted into the recessed portion so as to define a swing center of the movable part as a position near the center of the mounting surface. Thus, an optical actuator capable of reducing the size of a product is provided.

### CROSS REFERENCE TO RELATED APPLICATIONS

This application is entitled and claims the benefit of Japanese Patent Application No. 2021-139954, filed on Aug. 30, 2021, the disclosure of which including the specification, drawings and abstract is incorporated herein by reference in its entirety.

### TECHNICAL FIELD

The present invention relates to an optical actuator, a camera module, and a camera-mounted device.

### BACKGROUND ART

Conventionally, thin camera-mounted devices equipped with a camera module, such as smartphones and digital cameras, are known. Each of the camera modules includes a lens part including one or more lenses, and an image capturing device for capturing a subject image imaged by the lens part.

Further, there has been a proposal for a camera module having a bending optical system for guiding light to the lens part by bending, in a direction of a second optical axis, the light from the subject along a first optical axis using a prism disposed upstream of the lens part (e.g., Patent Literature (hereinafter referred to as “PTL”) 1).

The camera module disclosed in PTL 1 includes a shake correction device that corrects a shake occurring in a camera, and an autofocus device that performs autofocus. Such a camera module includes a shake correcting actuator and an auto-focusing actuator as an optical actuator. The shake correcting actuator among these actuators is provided with an actuator for causing the prism to swing.

### CITATION LIST

### Patent Literature

PTL 1
Japanese Patent Application Laid-Open No. 2020-126231

### SUMMARY OF INVENTION

### Technical Problem

In the case of the optical actuator as described above, the prism is swung about a ball disposed between a lower surface of a holder for holding the prism and an upper surface of a base facing the lower surface. Accordingly, the distance from the swing center of swing of the prism to the upper surface of the prism increases. Thus, the locus drawn by the prism at the time of swing becomes large. When the locus is large, the product size may increase.

An object of the present invention is to provide an optical actuator, a camera module, and a camera-mounted device capable of reducing the size of a product.

### Solution to Problem

One aspect of an optical actuator according to the present invention includes:

a movable part including a mounting surface for an optical path bending member, and a recessed portion extending toward a center of the mounting surface at a back side of the mounting surface, the movable part being swung by driving of a driving part; and

a fixing part including a protruding portion inserted into the recessed portion so as to define a swing center of the movable part as a position near the center of the mounting surface.

One aspect of a camera module according to the present invention includes: the above-described optical actuator; and an image capturing device disposed downstream of the lens part.

One aspect of a camera-mounted device according to the present invention includes: the above-described camera module; and a control part for controlling the camera module.

### Advantageous Effects of Invention

According to the present invention, it is possible to provide an optical actuator, a camera module, and a camera-mounted device capable of reducing the size of a product.

### BRIEF DESCRIPTION OF DRAWINGS

FIG. 1 is a perspective view schematically illustrating a camera module according to an embodiment of the present invention;

FIG. 2 is a perspective view of the camera module in which illustration of a cover is omitted;

FIG. 3 is a perspective view for explaining a first base and a second base;

FIG. 4 is a perspective view for explaining the first base and the second base;

FIG. 5 is a perspective view of a holder;

FIG. 6 is a perspective view of the holder;

FIG. 7 is a perspective view of a supporting wall portion of the first base;

FIG. 8A is a sectional view of an optical path bending module;

FIG. 8B is a sectional schematic view of the optical bending module;

FIG. 9 is a perspective view of an FPC;

FIG. 10 is a perspective view of the FPC;

FIG. 11 is a perspective view of a first driving part, a second driving part, and a third driving part;

FIG. 12 is a perspective view of a lens guide;

FIG. 13 is a perspective view of the lens guide;

FIG. 14 is a bottom view of the lens guide;

FIG. 15 is a perspective view of the lens guide to which a shock absorbing part is assembled;

FIG. 16 is a perspective view of the lens guide to which the shock absorbing part is assembled;

FIG. 17 is a partial cross-sectional view of the lens module taken along line X-X in FIG. 14;

FIG. 18 is a partial cross-sectional view of the lens module taken along line Y-Y in FIG. 14;

FIG. 19 is a partial cross-sectional view of the lens module taken along line Z-Z in FIG. 14;

FIG. 20 is a perspective view of the shock absorbing part;

FIG. 21 is a perspective view of the shock absorbing part;

FIG. 22A is a partial sectional view of the lens module for explaining the action of the shock absorbing part;

FIG. 22B is a partial cross-sectional view of the lens module for explaining the action of the shock absorbing part;

FIG. 23A is a diagram illustrating an exemplary camera-mounted device in which the camera module is mounted;

FIG. 23B is a diagram illustrating an exemplary camera-mounted device in which the camera module is mounted;

FIG. 24A is a diagram illustrating an automobile as a camera-mounted device in which an in-vehicle camera module is to be mounted; and

FIG. 24B is a diagram illustrating the automobile as the camera-mounted device in which the in-vehicle camera module is to be mounted.

### DESCRIPTION OF EMBODIMENTS

Hereinafter, an embodiment according to the present invention is described in detail with reference to the drawings. Note that an optical actuator, a camera module, and a camera-mounted device according to embodiments described below are examples of the optical actuator, the camera module, and the camera-mounted device according to the present invention. The present invention is not limited by the embodiments.

### Embodiments

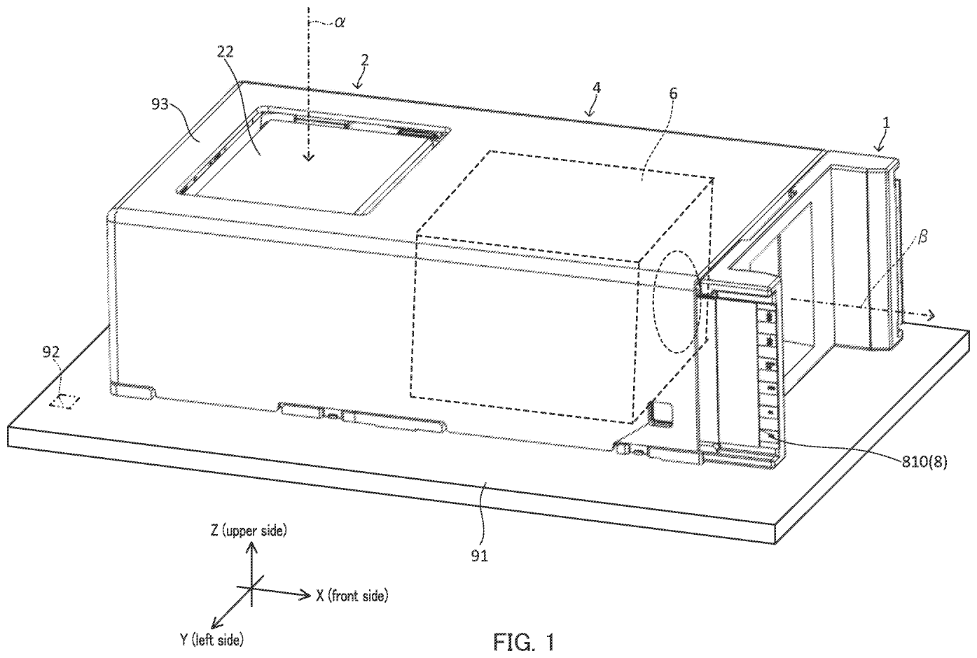

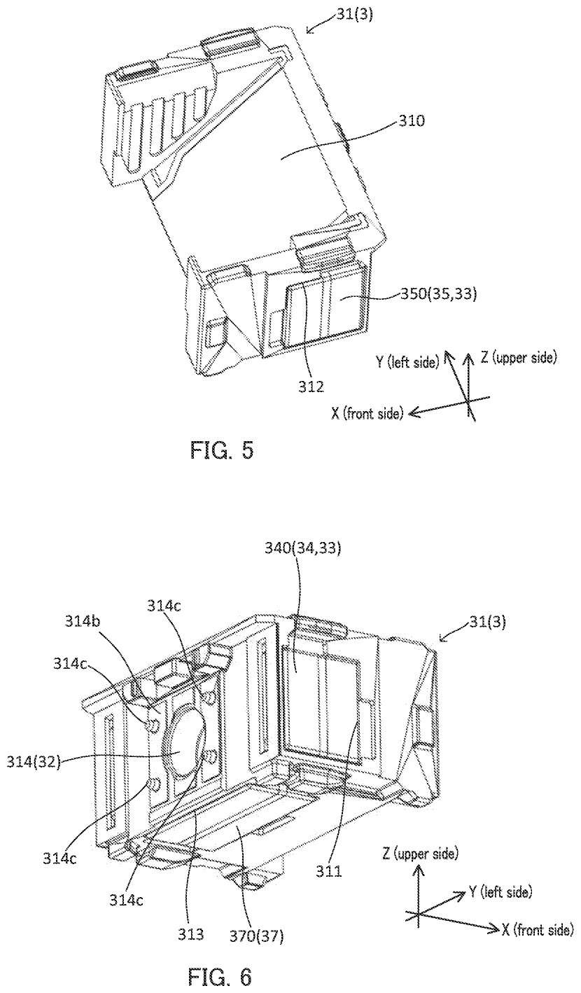

Referring to FIGS. 1 to 24B, camera module 1 according to an embodiment of the present disclosure will be described. Hereinafter, a description will be given of the outline of camera module 1, and then, the structure of optical path bending module 2, lens module 4, and image capturing device module 9 included by camera module 1 will be described. Note that the optical actuator, the camera module, and the camera-mounted device according to the present invention may have all configurations described later, or do not have to have some of the configurations.

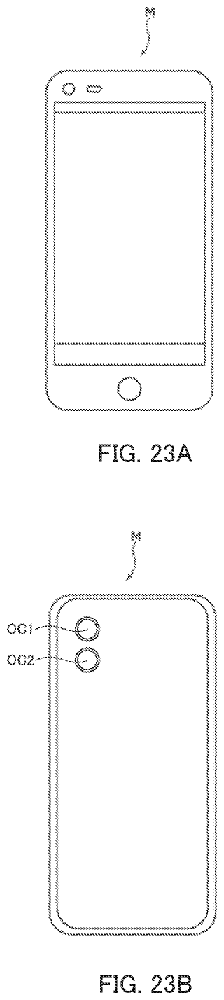

Camera module 1 is mounted, for example, in smartphone M (see FIG. 23A and FIG. 23B), a mobile phone, a digital camera, a notebook personal computer, a tablet terminal, a portable game machine, a thin camera-mounted device (in-vehicle camera), and the like. Smartphone M includes a dual camera consisting of two back side cameras OC1 and OC2. In the present embodiment, camera module 1 is applied to back side camera OC2.

Hereinafter, components constituting camera module 1 of the present embodiment will be described with reference to a state in which the components are incorporated in camera module 1. In explaining the structure of camera module 1 of the present embodiment, an orthogonal coordinate system (X, Y, Z) indicated in the figures is used.

Camera module 1 is mounted such that the horizontal (lateral) direction of the camera-mounted device is the X-direction, the vertical direction of the camera-mounted device is the Y-direction, and the front-rear direction of the camera-mounted device is the Z-direction, for example, during actual image capturing with the camera-mounted device. Light from a subject (incident light) is incident on prism 22 of optical path bending module 2 from the + side (plus side) of camera module 1 in the Z direction as illustrated by single-dot dashed line a in FIG. 1 (also referred to as “first optical axis”). Prism 22 corresponds to one example of an optical path bending member.

The light incident on prism 22 (emitted light) is bent by an optical path bending surface of prism 22 and guided to lens part 6 of lens module 4 disposed downstream of prism 22 (+ side in the X direction), as illustrated by single-dot dashed line R in FIG. 1 (also referred to as “second optical axis”).

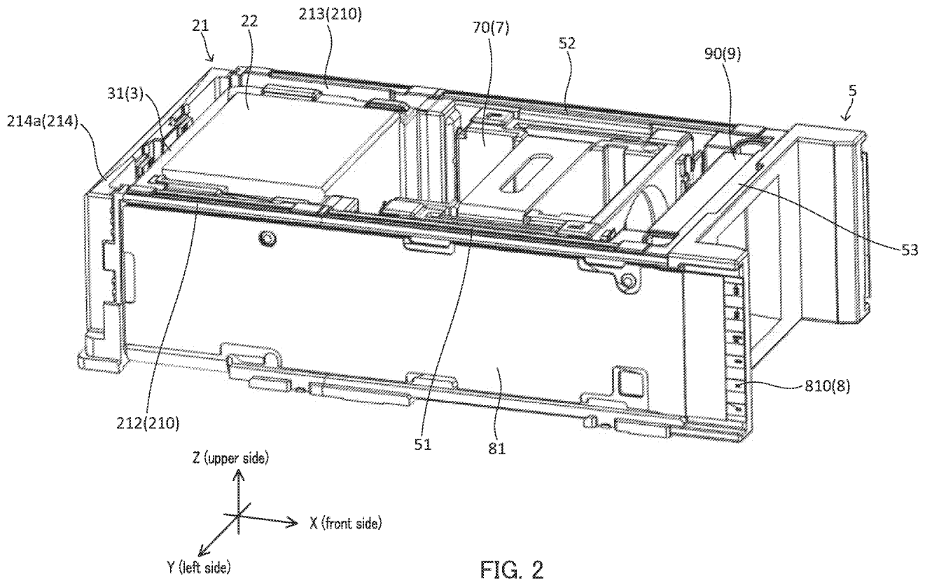

Then, a subject image imaged by lens part 6 is captured by image capturing device module 9 disposed downstream of lens module 4 (see FIG. 2).

Camera module 1 of the present embodiment performs Optical Image Stabilization (OIS) by optical image stabilization device 3 incorporated in optical path bending module 2. That is, optical path bending module 2 has an optical image stabilization function.

Further, camera module 1 of the present embodiment performs autofocus by displacing the lens part in the X direction using Auto Focus (AF) device 7 incorporated in lens module 4. That is, lens module 4 has an autofocus function.

(Optical Path Bending Module)

Optical path bending module 2 will be described with reference to FIGS. 1 to 11. Optical path bending module 2 includes cover 93, first base 21, prism 22, and optical image stabilization device 3.

First base 21 corresponds to one example of a fixing part. First base 21 includes supporting portion 214b inserted into recessed portion 314 of holder 31 so as to define a swing center of holder 31 as a position near the center of mounting surface 310 of holder 31.

Specifically, first base 21 includes first base main body 210 and supporting wall portion 214. First base 21 combined with cover 93 forms an accommodation space in which prism 22 and optical image stabilization device 3 can be disposed.

First base main body 210 corresponds to one example of a fixing-part main body, and is a U-shaped member that opens at the front end, the rear end, and the upper end. First base main body 210 includes bottom wall portion 211, left wall portion 212, and right wall portion 213. First base main body 210 is connected at a front end portion to second base 5, which will be described later. That is, first base main body 210 and second base 5 are integral with each other.

Bottom wall portion 211 has a plate shape parallel to the XY plane. Bottom wall portion 211 has second coil placement portion 211a for placing second coil 371 of second driving part 37. Second coil placement portion 211a is a through hole.

Left wall portion 212 has a plate shape parallel to the XZ plane and the lower end portion thereof is connected to the left end portion of bottom wall portion 211. Left wall portion 212 has left-side first coil placement portion 212a for placing left-side first coil 341 of first driving part 33. Left-side first coil placement portion 212a is a through hole.

Right wall portion 213 has a plate shape parallel to the XZ plane and the lower end portion thereof is connected to the right end portion of bottom wall portion 211. Right wall portion 213 includes right-side first coil placement portion 213a for placing right-side first coil 351 of first driving part 33. Right-side first coil placement portion 213a is a through hole.

Supporting wall portion 214 is a member separate from first base main body 210, and includes rear wall portion 214a and supporting portion 214b. Rear wall portion 214a has a plate shape parallel to the YZ plane. Rear wall portion 214a closes the rear end of first base main body 210. Rear wall portion 214a is supported by first base main body 210 via biasing spring 322 to be described later.

Supporting portion 214b is for supporting below-described holder 31 such that the holder is swingable, and is disposed on the front-side surface of rear wall portion 214a. Supporting portion 214b is formed by a protruding portion extending forward (+ side in the X direction) from rear wall portion 214a. Supporting portion 214b includes, at the tip end portion, protruding-portion-side tapered surface 214c in the shape of a cone whose inner diameter decreases toward the rear.

While inserted into recessed portion 314 of holder 31 described later, supporting portion 214b supports holder 31 via ball 321 such that the holder is swingable. A supporting aspect for supporting holder 31 by supporting portion 214b will be described later.

In the case of the present embodiment, supporting portion 214b is disposed on rear wall portion 214a of first base 21. However, the configuration of the supporting portion is not limited to that of the case of the present embodiment. For example, the supporting portion may be disposed on the bottom wall portion of the first base. In this case, the supporting portion may extend upward from the bottom wall portion of the first base. In this case, the recessed portion of the holder may be formed in the lower-side surface of the holder.

Next, optical image stabilization device 3 will be described. Optical image stabilization device 3 performs optical image stabilization in the rotational direction around first axis A1 parallel to the Z direction and the rotational direction around second axis A2 parallel to the Y direction by causing prism 22 to swing around first axis A1 and second axis A2. Such optical image stabilization device 3 is disposed in the accommodation space surrounded by cover 93 and first base 21. In the present embodiment, first axis A1 and second axis A2 are straight lines passing through ball 321.

Optical image stabilization device 3 includes holder 31, swing supporting portion 32, first driving part 33, and second driving part 37.

In optical image stabilization device 3, holder 31 is supported by first base 21 via swing supporting portion 32. Holder 31 is swingable with respect to first base 21 about first axis A1 and about second axis A2. Holder 31 in this state swings about first axis A1 based on a driving force generated by first driving part 33, and swings about second axis A2 based on a driving force generated by second driving part 37.

When first driving part 33 is driven under the control of control part 92 (see FIG. 1), holder 31 and prism 22 are swung about first axis A1. Thus, shake in the rotational direction around first axis A1 is corrected. Further, when second driving part 37 is driven under the control of control part 92 (see FIG. 1), holder 31 and prism 22 are swung about second axis A2. Thus, shake in the rotational direction around second axis A2 is corrected. Hereinafter, a specific structure of each member included in optical image stabilization device 3 will be described.

Holder 31 corresponds to one example of a movable part, and supports prism 22 (see FIG. 1) with respect to first base 21 such that the prism is swingable. Holder 31 includes mounting surface 310 for mounting prism 22, and recessed portion 314 extending toward the center of the mounting surface on the back side of mounting surface 310. The holder swings by the drive of first driving part 33 and second driving part 37.

Specifically, holder 31 is disposed in a space surrounded by bottom wall portion 211, left wall portion 212, right wall portion 213, and rear wall portion 214a of first base 21. Holder 31 is swingable about first axis A1 and is swingable about second axis A2 with respect to first base 21. Therefore, prism 22 is also swingable about first axis A1 and swingable about second axis A2 with respect to first base 21.

Holder 31 is made of, for example, a synthetic resin. Holder 31 includes mounting surface 310 on which prism 22 can be mounted. Mounting surface 310 is disposed between the left-side surface and the right-side surface of holder 31. The mounting surface is an inclined surface inclined to be situated lower (− side in the Z direction) toward the front (+ side in the X direction).

Holder 31 includes, on the left-side surface, left-side first magnet placement portion 311 for placing left-side first magnet 340 of first driving part 33 to be described later. Left-side first magnet placement portion 311 is formed by a recessed portion. Left-side first magnet placement portion 311 faces left-side first coil placement portion 212a of first base main body 210 in the left-right direction.

Holder 31 includes, on the right-side surface, right-side first magnet placement portion 312 for placing right-side first magnet 350 of first driving part 33 to be described later. Right-side first magnet placement portion 312 is formed by a recessed portion. Right-side first magnet placement portion 312 faces right-side first coil placement portion 213a of first base main body 210 in the left-right direction.

Holder 31 includes, on the lower-side surface, second magnet placement portion 313 for placing second magnet 370 of second driving part 37 to be described later. Second magnet placement portion 313 is formed by a recessed portion. Second magnet placement portion 313 faces second coil placement portion 211a of first base main body 210 in the upper-lower direction.

Holder 31 includes recessed portion 314 in the rear-side surface. Recessed portion 314 extends forward from the rear-side surface of holder 31. In other words, recessed portion 314 extends toward the central portion of mounting surface 310 from the rear-side surface of holder 31. The central axis of recessed portion 314 is parallel to the front-rear direction. Further, holder 31 includes spring fixation portion 314b around recessed portion 314 at the rear-side surface (see FIG. 6). Further, a plurality of locking protruding portions 314c (four locking protruding portions in the case of the present embodiment) are disposed on spring fixation portion 314b. Inner fixation portion 324 of biasing spring 322, which will be described later, is fixed to spring fixation portion 314b by a fixing means such as adhesion. In this state, locking protruding portions 314c are inserted respectively into locking holes 324b in inner fixation portion 324.

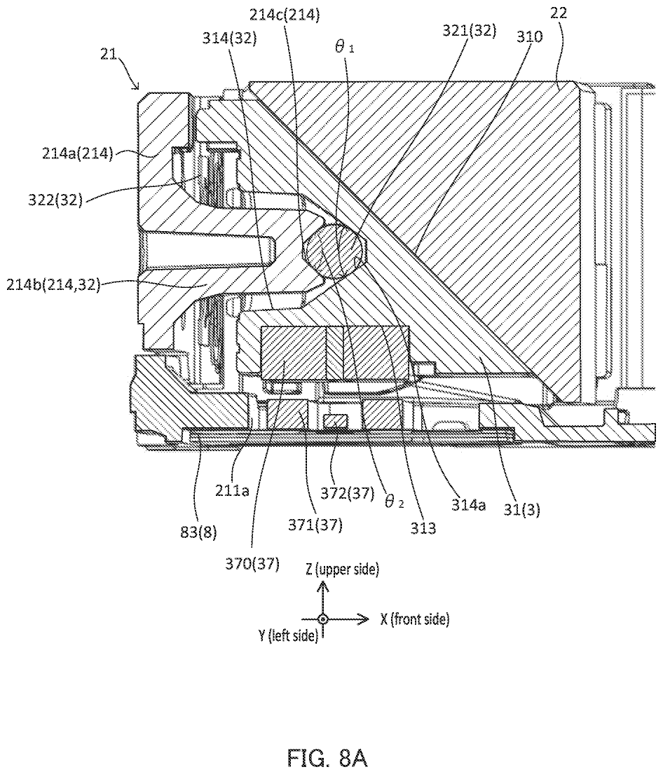

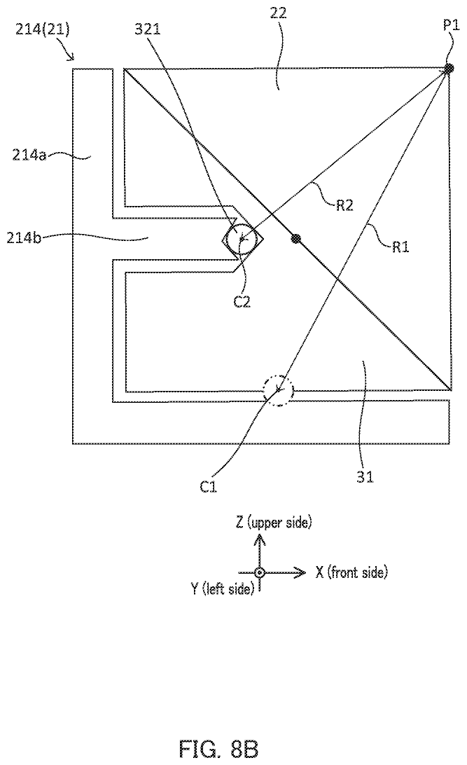

Recessed portion 314 includes, at an interior end portion, recessed-portion-side tapered surface 314a in the shape of a cone whose inner diameter decreases toward the front. Taper angle θ₁ (see FIG. 8A) of recessed-portion-side tapered surface 314a is smaller than taper angle θ₂ of protruding-portion-side tapered surface 214c of first base 21. When such a configuration is adopted, it becomes easier to secure the thickness around recessed portion 314 (near the central portion of mounting surface 310). It is thus possible to suppress a decrease in strength of holder 31.

Supporting portion 214b of first base 21 is inserted into recessed portion 314. The outer diameter of supporting portion 214b is smaller than the inner diameter of recessed portion 314. Therefore, the outer circumferential surface of supporting portion 214b is not in contact with the inner circumferential surface of recessed portion 314.

Holder 31 having the above-described configuration is accommodated in first base 21. In this state, holder 31 is supported by first base 21 by swing supporting portion 32 swingably with respect to first base 21.

Next, swing supporting portion 32 will be described. Swing supporting portion 32 includes supporting portion 214b of first base 21 described above, ball 321, recessed portion 314 of holder 31, and biasing spring 322.

As illustrated in FIG. 8A, supporting portion 214b is inserted into recessed portion 314. Further, ball 321 is disposed between protruding-portion-side tapered surface 214c of supporting portion 214b and recessed-portion-side tapered surface 314a of recessed portion 314. The center of ball 321 (i.e., the swing center of holder 31) and below-described second driving part 37 are disposed on the same straight line parallel to the Z direction.

Biasing spring 322 biases holder 31 rearward. In other words, biasing spring 322 biases recessed portion 314 toward supporting portion 214b. Therefore, ball 321 is sandwiched between protruding-portion-side tapered surface 214c and recessed-portion-side tapered surface 314a.

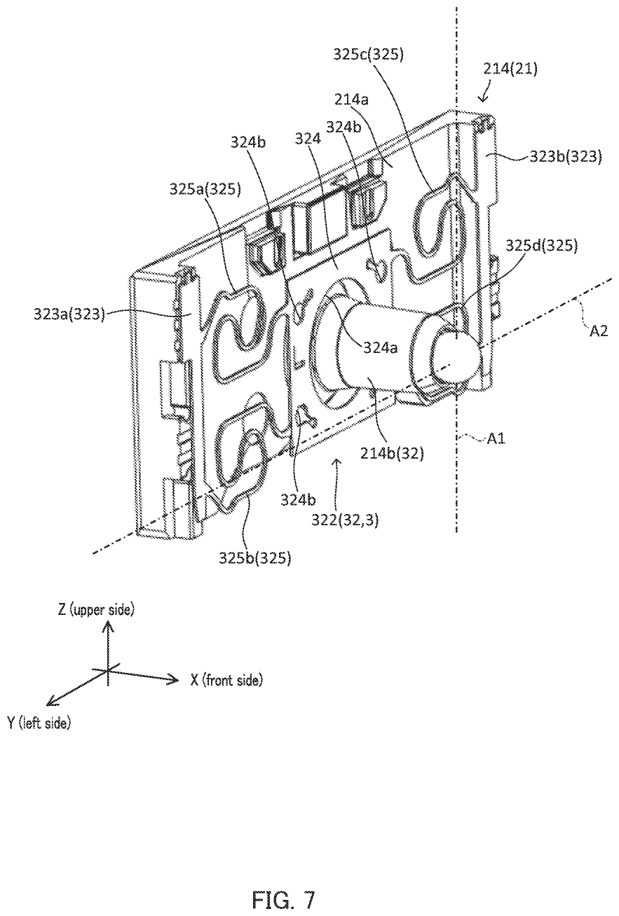

Specifically, biasing spring 322 corresponds to one example of a biasing member, and includes outer fixation portion 323, inner fixation portion 324, and connecting portion 325 as illustrated in FIG. 7.

Outer fixation portion 323 corresponds to one example of a first fixing part, has a plate shape parallel to the YZ plane, and is fixed to first base main body 210 of first base 21. Specifically, outer fixation portion 323 includes left-side fixation portion 323a and right-side fixation portion 323b. Left-side fixation portion 323a is fixed to the rear end portion of left wall portion 212 in first base main body 210. Right-side fixation portion 323b is fixed to the rear end portion of right wall portion 213 in first base main body 210.

Inner fixation portion 324 corresponds to one example of a second fixing part, and has a plate shape parallel to the YZ plane. Inner fixation portion 324 includes central hole 324a and a plurality of locking holes 324b (four locking holes in the present embodiment). Locking holes 324b are formed around central hole 324a. Inner fixation portion 324 is fixed to holder 31. Specifically, inner fixation portion 324 is fixed, by a fixing means such as adhesion, to spring fixation portion 314b disposed on the rear-side surface of holder 31. In this state, supporting portion 214b is inserted into central hole 324a in inner fixation portion 324, and locking protruding portions 314c disposed on spring fixation portion 314b are inserted into locking holes 324b in inner fixation portion 324, respectively.

Connecting portion 325 is elastically deformable and has a linear shape. The connecting portion connects outer fixation portion 323 to inner fixation portion 324. Specifically, connecting portion 325 includes a pair of left-side connecting portions 325a and 325b and a pair of right-side connecting portions 325c and 325d.

A pair of left-side connecting portions 325a and 325b and a pair of right-side connecting portions 325c and 325d have serpentine portions.

In the assembled state, connecting portion 325 is elastically deformed so as to bias inner fixation portion 324 rearward. Thus, biasing spring 322 biases holder 31 rearward toward supporting wall portion 214 based on a restoring force of connecting portion 325. As a result, recessed portion 314 of holder 31 is biased rearward toward supporting portion 214b by biasing spring 322.

First driving part 33 causes holder 31 to swing about first axis A1. First axis A1 is an axis parallel to the Z direction. Specifically, first axis A1 is an axis extending through the center of ball 321 of swing supporting portion 32 and being parallel to the Z direction. The center of ball 321 may be understood as the swing center of swing of holder 31 based on the drive of first driving part 33.

First driving part 33 includes left-side first driving part 34, right-side first driving part 35, and first position detecting element 36.

Left-side first driving part 34 is disposed between the left-side surface of holder 31 and left-side FPC 81 of Flexible Printed Circuit (FPC) 8 fixed to left wall portion 212 of first base 21.

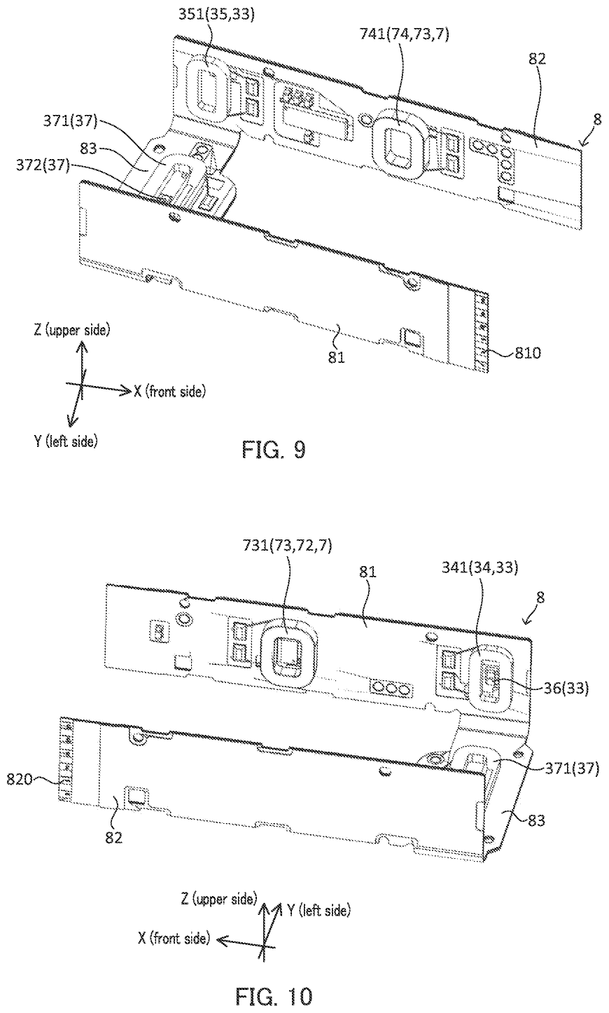

Referring now to FIGS. 9 and 10, FPC 8 will be described. FPC 8 includes left-side FPC 81, right-side FPC 82, and lower-side FPC 83.

Left-side FPC 81 has a plate shape parallel to the XZ plane, and extends in the front-rear direction toward lens module 4 from optical path bending module 2. Left-side FPC 81 is fixed to the left-side surface of optical path bending module 2 and lens module 4.

Left-side FPC 81 includes left-side terminal portion 810 composed of a plurality of terminals disposed on the front end portion of the left-side FPC in the upper-lower direction. Left-side terminal portion 810 is, for example, a terminal connected to the positive side of a power supply. Left-side terminal portion 810 is connected to left-side first coil 341 and first position detecting element 36 of first driving part 33, second coil 371 and second position detecting element 372 of second driving part 37, and left-side third coil 731 and third position detecting element 75 of third driving part 72 via interconnections disposed in FPC 8.

Right-side FPC 82 has a plate shape parallel to the XZ plane, and extends in the front-rear direction toward lens module 4 from optical path bending module 2. Right-side FPC 82 is fixed to the right-side surface of optical path bending module 2 and lens module 4.

Right-side FPC 82 includes right-side terminal portion 820 composed of a plurality of terminals disposed on the front end portion of the right-side FPC in the upper-lower direction. Right-side terminal portion 820 is, for example, a terminal connected to the negative side of the power supply. Right-side terminal portion 820 is connected to right-side first coil 351 and first position detecting element 36 of first driving part 33, second coil 371 and second position detecting element 372 of second driving part 37, and right-side third coil 741 and third position detecting element 75 of third driving part 72 via the interconnections disposed in FPC 8.

Lower-side FPC 83 has a plate shape parallel to the XY plane, and below optical path bending module 2, connects the lower end portion of left-side FPC 81 to the lower end portion of right-side FPC 82 in the left-right direction. Lower-side FPC 83 is fixed to the lower-side surface of optical path bending module 2.

The description of left-side first driving part 34 will be given again. Left-side first driving part 34 is a voice coil motor, and includes left-side first magnet 340 and left-side first coil 341.

Left-side first magnet 340 is disposed on left-side first magnet placement portion 311 of holder 31. Left-side first magnet 340 is fixed to left-side first magnet placement portion 311 of holder 31 by a fixing means such as adhesion.

Left-side first magnet 340 is composed of two magnet elements adjacent to each other in the front-rear direction. Each of these magnet elements is disposed such that the longitudinal direction coincides with the upper-lower direction. Further, each of these magnet elements is magnetized in the left-right direction, and has one magnetic pole on each side. The directions of the magnetic poles of the magnet elements are opposite to each other.

Left-side first coil 341 is a so-called air-core coil having an oval shape that is supplied with electricity during optical image stabilization. The long axis of left-side first coil 341 coincides with the upper-lower direction. Disposed on left-side first coil placement portion 212a of first base main body 210, left-side first coil 341 is fixed to left-side FPC 81 by a fixing means such as adhesion.

Left-side first coil 341 is disposed on the left side of left-side first magnet 340 (outside of the left-side first magnet in the width direction). Left-side first coil 341 faces left-side first magnet 340 in the left-right direction, with a predetermined gap being interposed in between.

In the case of the present embodiment, left-side first magnet 340 is disposed in the movable part, and left-side first coil 341 is disposed in the fixing part. However, left-side first magnet 340 may also be disposed in the fixing part, and left-side first coil 341 may also be disposed in the movable part.

Right-side first driving part 35 is disposed between the right-side surface of holder 31 and right-side FPC 82 of FPC 8 fixed to right wall portion 213 of first base 21.

Right-side first driving part 35 is also a voice coil motor, and includes right-side first magnet 350 and right-side first coil 351.

Right-side first magnet 350 is disposed on right-side first magnet placement portion 312 of holder 31. Right-side first magnet 350 is fixed to right-side first magnet placement portion 312 of holder 31 by a fixing means such as adhesion.

Right-side first magnet 350 is composed of two magnet elements adjacent to each other in the front-rear direction. Each of these magnet elements is disposed such that the longitudinal direction coincides with the upper-lower direction. Further, each of these magnet elements is magnetized in the left-right direction, and has one magnetic pole on each side. The directions of the magnetic poles of the magnet elements are opposite to each other.

Right-side first coil 351 is a so-called air-core coil having an oval shape that is supplied with electricity during optical image stabilization. The long axis of right-side first coil 351 coincides with the upper-lower direction. Disposed on right-side first coil placement portion 213a of first base main body 210, right-side first coil 351 is fixed to right-side FPC 82 by a fixing means such as adhesion. Right-side first coil 351 is electrically connected via FPC 8 to left-side first coil 341.

Right-side first coil 351 is disposed on the right side of right-side first magnet 350 (outside of the right-side first magnet in the width direction). Right-side first coil 351 faces right-side first magnet 350 in the left-right direction, with a predetermined gap being interposed in between.

In the case of the present embodiment, right-side first magnet 350 is disposed in the movable part, and right-side first coil 351 is disposed in the fixing part. However, right-side first magnet 350 may also be disposed in the fixing part, and right-side first coil 351 may also be disposed in the movable part.

First position detecting element 36 is fixed to left-side FPC 81 while being disposed at the central portion of left-side first coil 341, as illustrated in FIG. 10. First position detecting element 36 faces left-side first magnet 340 in the left-right direction. First position detecting element 36 detects a magnetic flux of left-side first magnet 340, and sends a detection value to control part 92 mounted on sensor board 91. Control part 92 determines the position of holder 31 around first axis A1 based on the detection value received from first position detecting element 36.

In the case of first driving part 33 having the above-described configuration, when a current flows through left-side first coil 341 and right-side first coil 351 via FPC 8 under the control of control part 92, the Lorentz force to displace left-side first magnet 340 and right-side first magnet 350 in the front-rear direction occurs.

Specifically, the Lorentz force toward one side in the front-rear direction acts on left-side first magnet 340. On the other hand, the Lorentz force directed toward the other side in the front-rear direction acts on right-side first magnet 350. As is understood, forces toward opposite sides in the front-rear direction act on left-side first magnet 340 and right-side first magnet 350, respectively.

Both of left-side first magnet 340 and right-side first magnet 350 are fixed to holder 31. Thus, holder 31 swings about first axis A1 based on the Lorentz force. By controlling the directions of the current flowing through left-side first coil 341 and right-side first coil 351, the moving direction (rotational direction) of holder 31 is switched.

Second driving part 37 causes holder 31 to swing about second axis A2. Second axis A2 is an axis extending through the center of ball 321 of swing supporting portion 32 and being parallel to the Y direction. The center of ball 321 may be understood as the swing center of swing of holder 31 based on the drive of second driving part 37.

Second driving part 37 includes second magnet 370, second coil 371, and second position detecting element 372. Second driving part 37 is disposed between the lower-side surface of holder 31 and bottom wall portion 211 of first base 21.

Second magnet 370 is disposed in second magnet placement portion 313 of holder 31. Second magnet 370 is fixed to second magnet placement portion 313 by a fixing means such as adhesion.

Second magnet 370 is composed of two magnet elements adjacent to each other in the front-rear direction. Each of these magnet elements is disposed such that the longitudinal direction coincides with the left-right direction. Each of these magnet elements is magnetized in the upper-lower direction, and has one magnetic pole on each side. The directions of the magnetic poles of the magnet elements are opposite to each other.

Second coil 371 is a so-called air-core coil having an oval shape that is supplied with electricity during optical image stabilization. Second coil 371 is disposed such that the long axis coincides with the left-right direction. While being disposed on second coil placement portion 211a of first base 21, second coil 371 is fixed to lower-side FPC 83 of FPC 8.

Second coil 371 is disposed below second magnet 370. Second coil 371 faces second magnet 370 in the upper-lower direction, with a predetermined gap being interposed in between.

While being disposed at the central portion of second coil 371, second position detecting element 372 (see FIGS. 8A and 9) is fixed to lower-side FPC 83. Second position detecting element 372 faces second magnet 370 in the upper-lower direction. Second position detecting element 372 detects a magnetic flux of second magnet 370, and sends a detection value to control part 92 mounted on sensor board 91. Control part 92 determines the position of holder 31 around second axis A2 based on the detection value received from second position detecting element 372.

In the case of second driving part 37 having the above-described configuration, when a current flows via FPC 8 to second coil 371 under the control of control part 92, the Lorentz force to move second magnet 370 on one side in the front-rear direction is generated.

Second magnet 370 is fixed to holder 31. Thus, holder 31 is swung about second axis A2 based on the Lorentz force. By controlling the directions of the current flowing through second coil 371, the moving direction (rotational direction) of holder 31 is switched.

(Lens Module)

Next, lens module 4 will be described with reference to FIGS. 1 to 4 and 11 to 21. Lens module 4 includes cover 93, second base 5, lens part 6, AF device 7, and shock absorbing part 76.

Second base 5 is combined with cover 93 to form an accommodation space in which lens part 6 and AF device 7 can be disposed. Second base 5 supports lens guide 70 of lens part 6 via support mechanism 71 described later.

Second base 5 includes bottom wall portion 50, left wall portion 51, right wall portion 52, and front wall portion 53. The rear end portion of second base 5 is connected to the front end portion of first base 21. Therefore, first base 21 and second base 5 are integrated with each other.

Bottom wall portion 50 has a rectangular plate shape parallel to the XY plane. Bottom wall portion 50 forms a bottom portion of second base 5. The rear end portion of bottom wall portion 50 is connected to bottom wall portion 211 of first base main body 210.

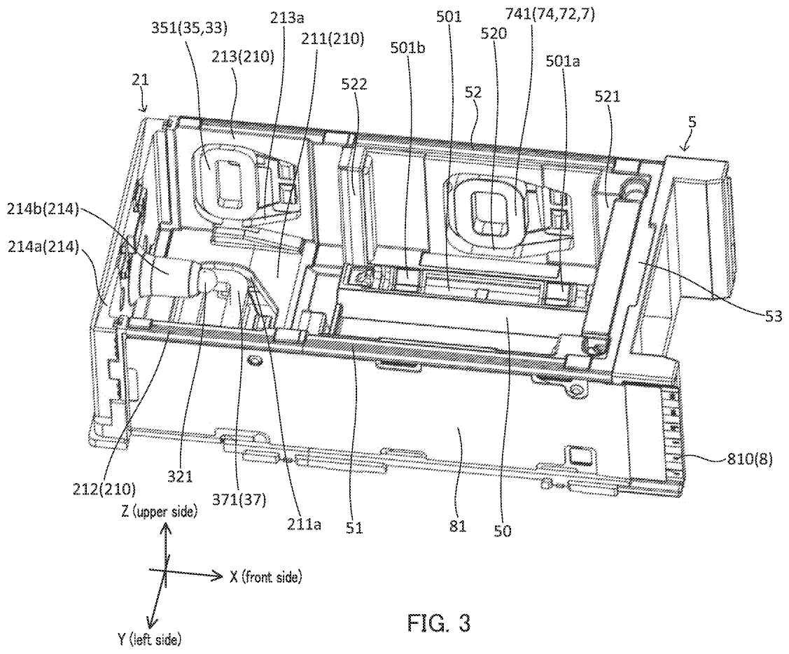

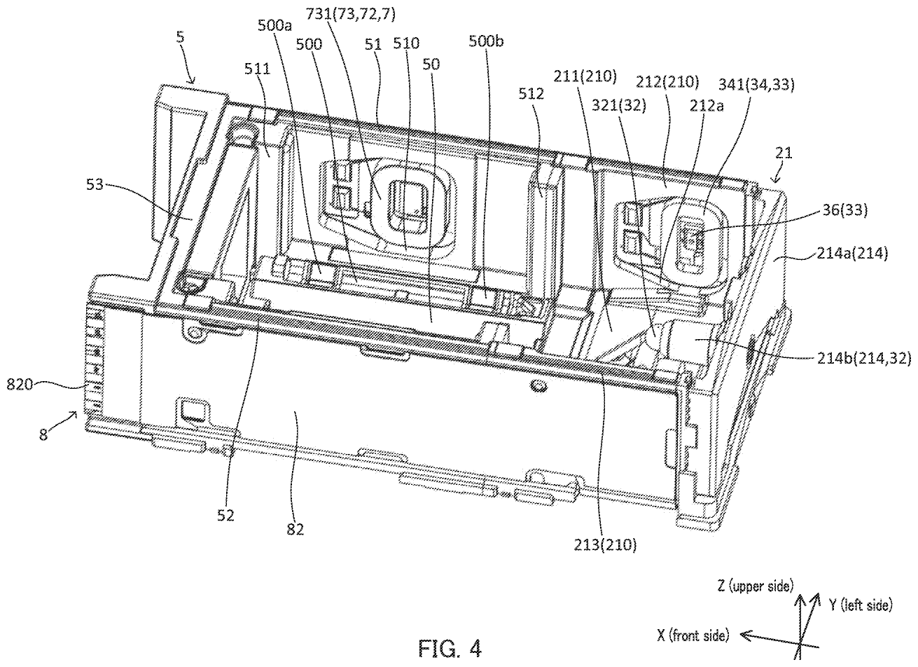

Bottom wall portion 50 includes, at the upper surface, left-side groove portion 500 (see FIG. 4) and right-side groove portion 501 (see FIG. 3). Left-side groove portion 500 and right-side groove portion 501 are spaced apart from each other in the left-right direction, and are parallel to each other. Left-side groove portion 500 and right-side groove portion 501 extend in the front-rear direction.

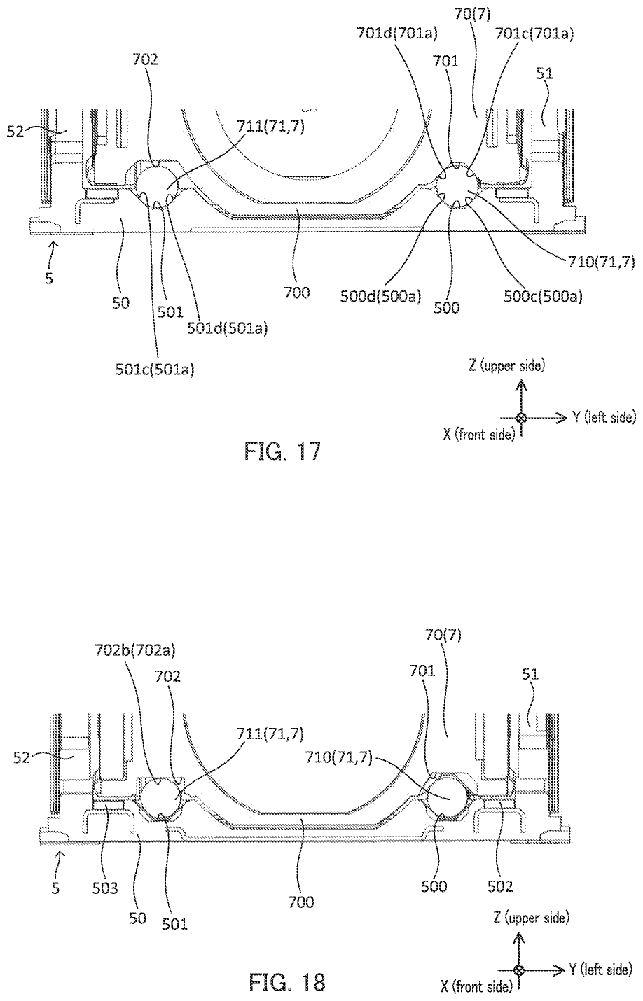

Left-side groove portion 500 includes left-side first supporting portions 500a and 500b (see FIG. 4) at two places in the front-rear direction. Left-side first supporting portion 500a is disposed at the front end portion of left-side groove portion 500. Left-side first supporting portion 500a includes a pair of tapered support surfaces 500c and 500d formed in a V-shape as illustrated in FIG. 17.

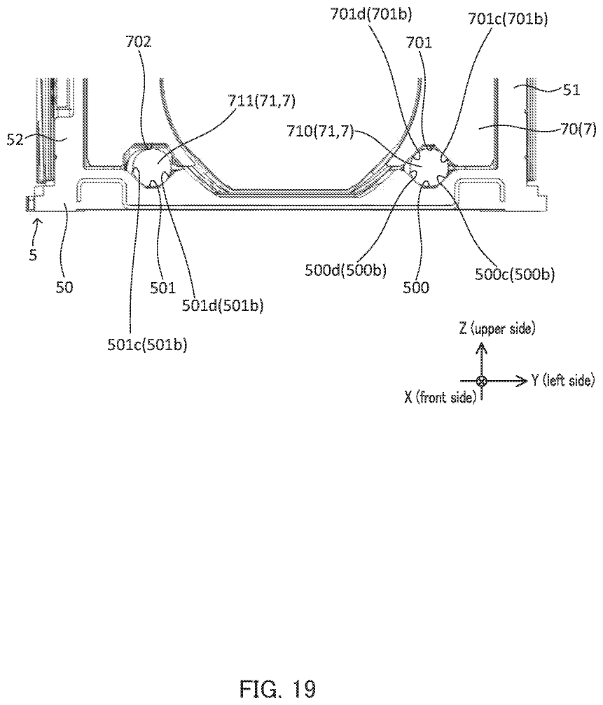

Left-side first supporting portion 500b is disposed at the rear end portion of left-side groove portion 500. Left-side first supporting portion 500b includes a pair of tapered support surfaces 500c and 500d formed in a V-shape as illustrated in FIG. 19.

A lower half portion of left-side shaft 710 is disposed in left-side groove portion 500 as illustrated in FIGS. 17 to 19. Left-side shaft 710 is cylindrical, and is disposed such that the central axis coincides with the front-rear direction. Left-side shaft 710 is supported from below by left-side first supporting portions 500a and 500b in left-side groove portion 500. Left-side shaft 710 is supported by second base 5 at two places in the axial direction.

Further, left-side shaft 710 makes contact with pairs of tapered support surfaces 500c and 500d of left-side first supporting portions 500a and 500b at the respective two places in the axial direction (front-rear direction). Therefore, left-side shaft 710 makes contact with second base 5 at the two places in the width direction at each of the two places in the axial direction (front-rear direction). Note that, the contact between left-side shaft 710 and the pair of tapered support surfaces 500c and 500d is a line contact.

Further, the front end surface of left-side shaft 710 is in contact with the front end portion of left-side groove portion 500. The rear end surface of left-side shaft 710 is in contact with the rear end portion of left-side groove portion 500. With such a configuration, left-side shaft 710 is positioned with respect to second base 5 in the front-rear direction.

Right-side groove portion 501 includes right-side first supporting portions 501a and 501b (see FIG. 3) at two places in the front-rear direction. Right-side first supporting portion 501a is disposed at the front end portion of right-side groove portion 501. Right-side first supporting portion 501a includes a pair of tapered support surfaces 501c and 501d formed in a V-shape as illustrated in FIG. 17.

Right-side first supporting portion 501b is disposed at the rear end portion of right-side groove portion 501. Right-side first supporting portion 501b includes a pair of tapered support surfaces 501c and 501d formed in a V-shape as illustrated in FIG. 19.

A lower half portion of right-side shaft 711 is disposed in right-side groove portion 501 as illustrated in FIGS. 17 to 19. Right-side shaft 711 is cylindrical, and is disposed such that the central axis coincides with the front-rear direction. Right-side shaft 711 is supported from below by right-side first supporting portions 501a and 501b in right-side groove portion 501. Right-side shaft 711 is supported by second base 5 at two places in the axial direction.

Further, right-side shaft 711 makes contact with pairs of tapered support surfaces 501c of 501d of right-side first supporting portions 501a and 501b at the respective two places in the axial direction (front-rear direction). Therefore, right-side shaft 711 makes contact with second base 5 at the two places in the width direction at each of the two places in the axial direction (front-rear direction). The contact between right-side shaft 711 and the pair of tapered support surfaces 501c and 501d is a line contact.

Further, the front end surface of right-side shaft 711 is in contact with the front end portion of right-side groove portion 501. The rear end surface of right-side shaft 711 is in contact with the rear end portion of right-side groove portion 501. With such a configuration, right-side shaft 711 is positioned with respect to second base 5 in the front-rear direction.

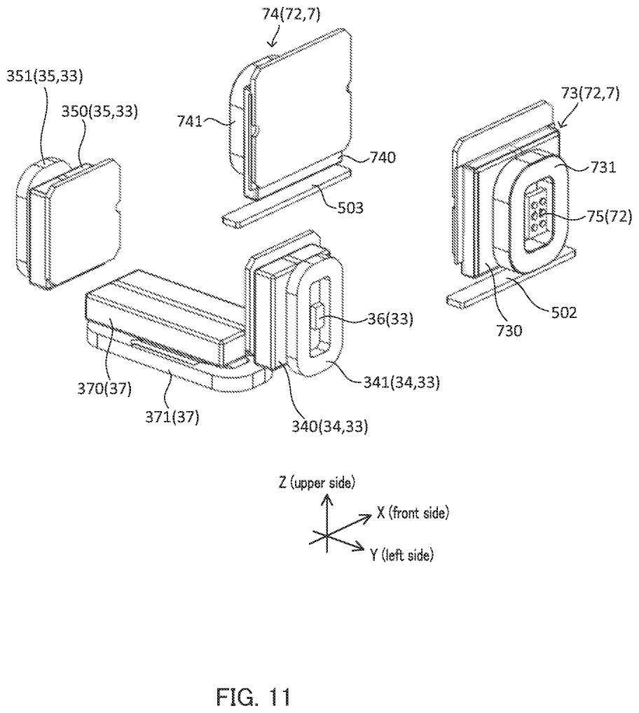

Left-side yoke 502 (see FIG. 11) is disposed on bottom wall portion 50 at a position facing below-described left-side third magnet 730 in the upper-lower direction. Further, right-side yoke 503 (see FIG. 11) is disposed on bottom wall portion 50 at a position facing below-described right-side third magnet 740 in the upper-lower direction. Based on the attractive force between left-side yoke 502 and left-side third magnet 730, and, the attractive force between right-side yoke 503 and right-side third magnet 740, lens guide 70 to be described later is biased downward toward bottom wall portion 50 of second base 5.

Left wall portion 51 has a plate shape parallel to the XZ plane and the lower end portion thereof is connected to the left end portion of bottom wall portion 50. Left wall portion 51 includes left-side third coil placement portion 510 for placing left-side third coil 731 of third driving part 72 (see FIG. 4). Left-side third coil placement portion 510 is a through hole.

Left wall portion 51 includes front-side stopper portion 511 (see FIG. 4) at the front end portion of the inner-side surface (right-side surface). Front-side stopper portion 511 has a rectangular plate shape extending from the inner-side surface of left wall portion 51 to the right side (on the inner side in the width direction). The rear end surface of front-side stopper portion 511 faces the front end surface of left wall portion 703 of below-described lens guide 70 in the front-rear direction. The rear end surface of front-side stopper portion 511 functions as a stopper surface for restricting forward movement of lens guide 70 in a predetermined range.

Left wall portion 51 includes rear-side stopper portion 512 (see FIG. 4) at the rear end portion of the inner-side surface (right-side surface). Rear-side stopper portion 512 has a rectangular plate shape extending from the inner-side surface of left wall portion 51 to the right side (inner side in the width direction). The front end surface of rear-side stopper portion 512 faces the rear end surface of left wall portion 703 of below-described lens guide 70 in the front-rear direction. The front end surface of rear-side stopper portion 512 functions as a stopper surface for restricting the rearward movement of lens guide 70 in a predetermined range.

Right wall portion 52 has a plate shape parallel to the XZ plane and the lower end portion thereof is connected to the right end portion of bottom wall portion 50. Right wall portion 52 includes right-side third coil placement portion 520 for placing right-side third coil 741 of third driving part 72 (see FIG. 3). Right-side third coil placement portion 520 is a through hole.

Right wall portion 52 includes front-side stopper portion 521 (see FIG. 3) at the front end portion of the inner-side surface (left-side surface). Front-side stopper portion 521 has a rectangular plate shape extending from the inner-side surface of right wall portion 52 to the left (inner side in the width direction). The rear end surface of front-side stopper portion 521 faces the front end surface of right wall portion 704 of below-described lens guide 70 in the front-rear direction. The rear end surface of front-side stopper portion 521 functions as a stopper surface for restricting the forward movement of lens guide 70 in a predetermined range.

Right wall portion 52 includes rear-side stopper portion 522 (see FIG. 3) at the rear end portion of the inner-side surface (left-side surface). Rear-side stopper portion 522 has a rectangular plate shape extending from the inner-side surface of right wall portion 52 to the left side (inner side in the width direction). The front end surface of rear-side stopper portion 522 faces the rear end surface of right wall portion 704 of below-described lens guide 70 in the front-rear direction. The front end surface of rear-side stopper portion 522 functions as a stopper surface for restricting the rearward movement of lens guide 70 in a predetermined range.

Front wall portion 53 has a rectangular frame shape parallel to the YZ plane. Image capturing device 90 of image capturing device module 9 is disposed on second base 5 at a position adjacent to the rear-side surface of front wall portion 53. Image capturing device 90 is an image capturing device such as, for example, a charge-coupled device (CCD) image capturing device, a complementary metal oxide semiconductor (CMOS) image capturing device.

Lens part 6 (see FIG. 1) is held by lens guide 70 described later. Lens part 6 includes a cylindrical lens barrel and one or more lenses held by the lens barrel. For example, lens part 6 is fixed between an end portion of the lens barrel on the − side in the X-direction and an end portion of the lens barrel on the + side in the X-direction, and includes a telephoto lens group of optical lenses with a magnification of three or more times.

AF device 7 moves lens part 6 in a direction parallel to the second optical axis (X direction) for the purpose of autofocus. Specifically, AF device 7 includes lens guide 70, support mechanism 71, and third driving part 72.

Lens guide 70 holds the lens barrel of lens part 6. Lens guide 70 is supported by second base 5 via support mechanism 71 to be capable of moving at least in the direction of the second optical axis (X direction).

Lens guide 70 has a U-shape that opens frontward, rearward, and upward. Specifically, lens guide 70 includes bottom wall portion 700, left wall portion 703, and right wall portion 704.

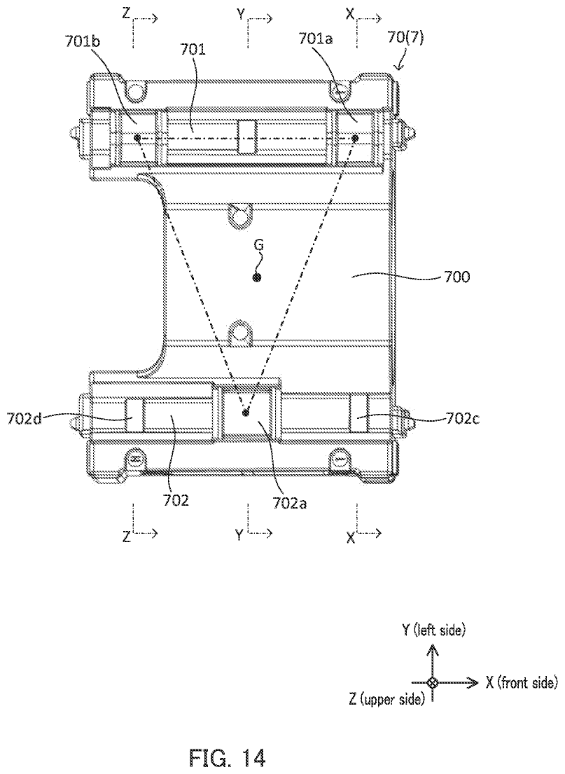

Bottom wall portion 700 faces bottom wall portion 50 of second base 5 via a gap in the upper-lower direction. Bottom wall portion 700 includes left-side groove portion 701 and right-side groove portion 702 in the lower surface as illustrated in FIGS. 13 and 14. Left-side groove portion 701 and right-side groove portion 702 are spaced apart from each other in the left-right direction, and are parallel to each other.

Left-side groove portion 701 and right-side groove portion 702 corresponds respectively to one examples of a first groove and a second groove, and extend in the front-rear direction. Left-side groove portion 701 and right-side groove portion 702 face left-side groove portion 500 and right-side groove portion 501 of second base 5 in the upper-lower direction.

Left-side groove portion 701 includes left-side second supporting portions 701a and 701b at two places in the front-rear direction. Left-side second supporting portion 701a corresponds to one example of a support surface, and is disposed at the front end portion of left-side groove portion 701. Left-side second supporting portion 701b corresponds to one example of the support surface, and is disposed at the rear end portion of left-side groove portion 701.

Left-side second supporting portions 701a and 701b face left-side first supporting portions 500a and 500b of second base 5 in the upper-lower direction, respectively. Left-side second supporting portion 701a includes a pair of tapered support surfaces 701c and 701d formed in a V-shape (see FIG. 17). Left-side second supporting portion 701b includes a pair of tapered support surfaces 701c and 701d formed in a V-shape.

An upper half portion of left-side shaft 710 is disposed in left-side groove portion 701 as illustrated in FIGS. 17 to 19. Left-side shaft 710 makes contact with left-side second supporting portions 701a and 701b in left-side groove portion 701 from below. Left-side shaft 710 supports lens guide 70 from below at two places in the axial direction.

Specifically, left-side shaft 710 is in contact with pairs of tapered support surfaces 701c and 701d of left-side second supporting portions 701a and 701b at the respective two places in the axial direction (front-rear direction). Therefore, left-side shaft 710 is in contact with lens guide 70 at two places at each of the two places in the axial direction (front-rear direction).

The contact between left-side shaft 710 and the pair of tapered support surfaces 701c and 701d is a line contact. The front and rear end surfaces of left-side shaft 710 are not in contact with lens guide 70.

In the present embodiment, left-side groove portion 701 has a constricted shape such that the space in the groove portion is narrowed by (becomes shallower and/or narrower) by tapered support surfaces 701c and 701d of left-side second supporting portions 701a and 701b. Therefore, in a normal state, left-side shaft 710 and left-side groove portion 701 do not make contact with each other at other portions than left-side second supporting portions 701a and 701b.

Right-side groove portion 702 includes right-side second supporting portion 702a at one place in the front-rear direction. Right-side second supporting portion 702a is disposed at the central portion of right-side groove portion 702 in the front-rear direction. Right-side second supporting portion 702a includes curved support surface 702b protruding downward. Support surface 702b is a curved surface around a central axis parallel to the Y direction. Further, support surface 702b is formed in a flat shape in a cross section viewed in the X direction. The cross section viewed in the X direction means a cross section of support surface 702b taken along a plane parallel to the YZ plane. Further, the flat shape in the cross section viewed in the X direction means that there is no or almost no corners, irregularities, and/or curves in the cross section.

The position of right-side second supporting portion 702a in the front-rear direction is between left-side second supporting portion 701a and left-side second supporting portion 701b. Further, a straight line parallel to the Z direction and passing through the center of gravity G of lens guide 70 on which lens part 6 is mounted extends through a triangular region formed by straight lines connecting the positions of right-side second supporting portion 702a, left-side second supporting portion 701a, and left-side second supporting portion 701b (see FIG. 14). Such a configuration can stably support lens guide 70 with respect to second base 5.

An upper half portion of right-side shaft 711 is disposed in right-side groove portion 702 as illustrated in FIGS. 17 to 19. Right-side shaft 711 makes contact with right-side second supporting portion 702a from below right-side groove portion 702 as illustrated in FIG. 18. Right-side shaft 711 supports lens guide 70 from below at one place in the axial direction.

Specifically, right-side shaft 711 is in contact with support surface 702b of right-side second supporting portion 702a at one place in the axial direction (front-rear direction). The contact between support surface 702b and right-side shaft 711 is a point contact. Such a configuration can stably move lens guide 70. The front and rear end surfaces of right-side shaft 711 are not in contact with lens guide 70.

In the present embodiment, right-side groove portion 702 has a constricted shape such that the space in the groove portion is narrowed (becomes shallower and/or narrower) by support surface 702b of right-side second supporting portion 702a. Therefore, in the normal state, right-side shaft 711 and right-side groove portion 702 are not in contact with each other at other portions than right-side second supporting portion 702a. Note that, when lens guide 70 is inclined with respect to the front-rear direction at a predetermined angle or at an angle greater than the predetermined angle, the upper end of right-side shaft 711 comes into contact with front-side stopper portion 702c or rear-side stopper portion 702d to be described later.

Further, right-side groove portion 702 includes front-side stopper portion 702c and rear-side stopper portion 702d as illustrated in FIG. 14. Front-side stopper portion 702c is disposed in front of right-side second supporting portion 702a in the front-rear direction. Rear-side stopper portion 702d is disposed in rear of right-side second supporting portion 702a in the front-rear direction.

Each of front-side stopper portion 702c and rear-side stopper portion 702d is a protruding portion protruding downward from the bottom portion of right-side groove portion 702. The positions of front-side stopper portion 702c and rear-side stopper portion 702d in the upper-lower direction are above the lower end portion of support surface 702b of right-side second supporting portion 702a (tip end portion).

Front-side stopper portion 702c and rear-side stopper portion 702d do not make contact with right-side shaft 711 in a state where lens guide 70 is parallel to the front-rear direction. Meanwhile, in a state in which lens guide 70 is inclined with respect to the front-rear direction (in other words, a state in which lens guide 70 is rotated about an axis parallel to the Y direction), front-side stopper portion 702c or rear-side stopper portion 702d makes contact with the upper end of right-side shaft 711. Thus, front-side stopper portion 702c and rear-side stopper portion 702d suppress a significant inclination of lens guide 70 with respect to the front-rear direction.

Left wall portion 703 has a plate-shape parallel to the XZ plane, and the lower end portion thereof is connected to the left end portion of bottom wall portion 700. Left wall portion 703 includes left-side third magnet placement portion 703a for placing left-side third magnet 730 of third driving part 72 on the left-side surface (outer-side surface in the width direction). Left-side third magnet placement portion 703a is a recessed portion.

Left wall portion 703 includes a plurality of front-side damper holding portions 703b, 703c, and 703d (three front-side damper holding portions in the case of the present embodiment) on the left half portion of the front end surface (see FIG. 13). Front-side damper holding portions 703b, 703c, and 703d are portions for holding damper members 77 of shock absorbing part 76 to be described later. Front-side damper holding portions 703b, 703c, and 703d are annular protruding portions, and are disposed side by side in the upper-lower direction.

Left wall portion 703 includes front-side leaf-spring fixation portion 703h in the right half portion of the front end surface (see FIG. 13). As illustrated in FIG. 16, fixation portion 780 of leaf spring 78 of below-described left-side first shock absorbing part 76a is fixed to front-side leaf-spring fixation portion 703h. Front-side leaf-spring fixation portion 703h is a portion that does not make contact with second base 5 at the time of AF.

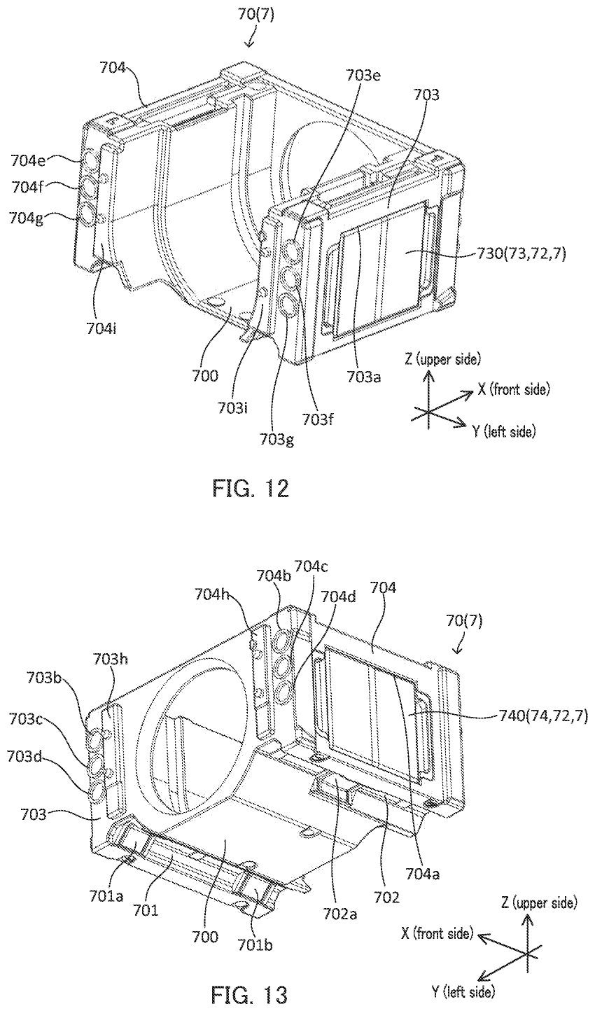

Left wall portion 703 includes a plurality of rear-side damper holding portions 703e, 703f, and 703g (three rear-side damper holding portions in the case of the present embodiment) on the left half portion of the rear end surface (see FIG. 12). Rear-side damper holding portions 703e, 703f, and 703g are portions for holding damper members 77 of shock absorbing part 76 described later. Rear-side damper holding portions 703e, 703f, and 703g are annular protruding portions, and are disposed side by side in the upper-lower direction.

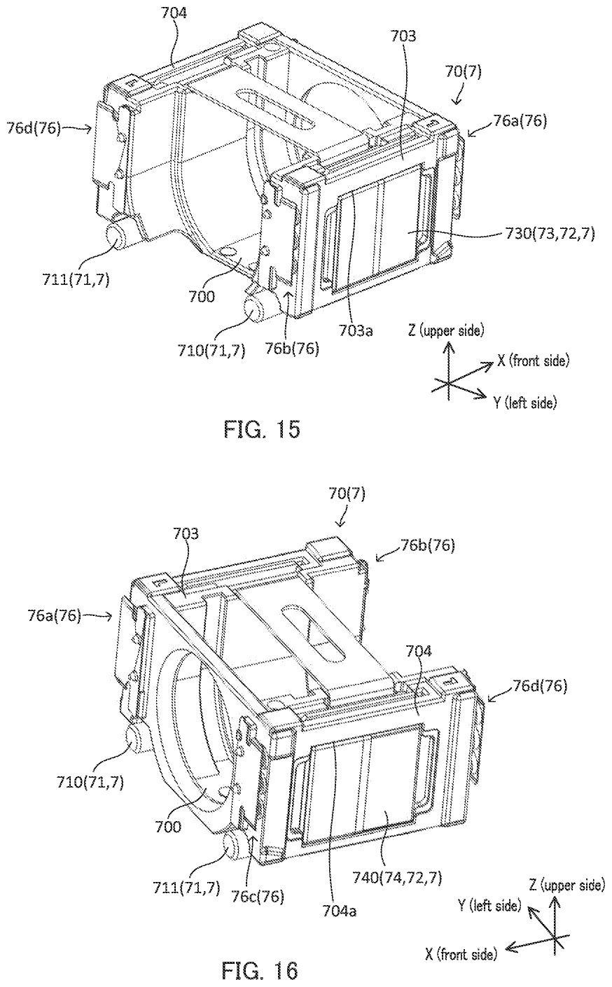

Left wall portion 703 includes rear-side leaf-spring fixation portion 703i on the right half portion of the rear end surface (see FIG. 12). As illustrated in FIG. 15, fixation portion 780 of leaf spring 78 in below-described left-side second shock absorbing part 76b is fixed to rear-side leaf-spring fixation portion 703i. Rear-side leaf-spring fixation portion 703i is a portion that does not contact second base 5 during AF.

Right wall portion 704 has a plate shape parallel to the XZ plane, and the lower end portion thereof is connected to the right end portion of bottom wall portion 700. Right wall portion 704 includes, on the outer-side surface (left-side surface), right-side third magnet placement portion 704a for placing right-side third magnet 740 of third driving part 72. Right-side third magnet placement portion 704a is a recessed portion.

Right wall portion 704 includes a plurality of front-side damper holding portions 704b, 704c, and 704d (three front-side damper holding portions in the case of the present embodiment) on the right half portion of the front end surface (see FIG. 13). Front-side damper holding portions 704b, 704c, and 704d are portions for holding damper members 77 of shock absorbing part 76 to be described later. Front-side damper holding portions 704b, 704c, and 704d are annular protruding portions, and are disposed side by side in the upper-lower direction.

Right wall portion 704 includes front-side leaf-spring fixation portion 704h on the left half portion of the front end surface (see FIG. 13). Fixation portion 780 of leaf spring 78 in below-described right-side first shock absorbing part 76c is fixed to front-side leaf-spring fixation portion 704h as illustrated in FIG. 16. Front-side leaf-spring fixation portion 704h is a portion that does not make contact with second base 5 at the time of AF.

Right wall portion 704 includes a plurality of rear-side damper holding portions 704e, 704f, and 704g (three rear-side damper holding portions in the case of the present embodiment) (see FIG. 12) on the right half portion of the rear end surface. Rear-side damper holding portions 704e, 704f, and 704g are portions for holding damper members 77 of shock absorbing part 76 described later. Rear-side damper holding portions 704e, 704f, and 704g are annular protruding portions, and are disposed side by side in the upper-lower direction.

Right wall portion 704 includes rear-side leaf-spring fixation portion 704i on the left half portion of the rear end surface (see FIG. 12). Fixation portion 780 of leaf spring 78 in below-described right-side second shock absorbing part 76d is fixed to rear-side leaf-spring fixation portion 704i as illustrated in FIG. 15. Rear-side leaf-spring fixation portion 704i is a portion that does not make contact with second base 5 during AF.

Lens guide 70 having the above configuration holds lens part 6 in a space defined by bottom wall portion 700, left wall portion 703, and right wall portion 704 (see FIG. 1). Lens guide 70 is supported by second base 5 via support mechanism 71. Lens guide 70 is movable with respect to second base 5 in the axial direction. Upon movement, lens guide 70 moves while sliding on left-side shaft 710 and right-side shaft 711 of support mechanism 71 to be described later.

Support mechanism 71 is a mechanism for supporting lens guide 70 with respect to second base 5. Support mechanism 71 is composed of left-side shaft 710 and right-side shaft 711 described above. Left-side shaft 710 and right-side shaft 711 correspond to one examples of a first shaft and a second shaft. The lower half portions of left-side shaft 710 and right-side shaft 711 are disposed in left-side groove portion 500 and right-side groove portion 501 of bottom wall portion 50 of second base 5 as illustrated in FIGS. 17 to 19. The upper half portions of left-side shaft 710 and right-side shaft 711 are disposed in left-side groove portion 701 and right-side groove portion 702 of bottom wall portion 700 of lens guide 70 as illustrated in FIGS. 17 to 19. That is, lens guide 70 is placed on left-side shaft 710 and right-side shaft 711.

Third driving part 72 is an actuator for moving lens guide 70 in the direction of the second optical axis (X direction). Third driving part 72 includes left-side third driving part 73, right-side third driving part 74, and third position detecting element 75.

Left-side third driving part 73 is disposed between left wall portion 703 of lens guide 70 and left-side FPC 81 fixed to the left-side surface (outer-side surface in the width direction) of left wall portion 51 of second base 5. Left-side third driving part 73 is a voice coil motor and includes left-side third magnet 730 and left-side third coil 731.

Left-side third magnet 730 is disposed on left-side third magnet placement portion 703a of lens guide 70. Left-side third magnet 730 is fixed to left-side third magnet placement portion 703a of lens guide 70 by a fixing means such as adhesion.

Left-side third magnet 730 is composed of two magnet elements adjacent to each other in the front-rear direction. Each of these magnet elements is disposed such that the longitudinal direction coincides with the upper-lower direction. Further, each of these magnet elements is magnetized in the left-right direction, and has one magnetic pole on each side. The directions of the magnetic poles of the magnet elements are opposite to each other.

Left-side third coil 731 is a so-called air-core coil having an oval shape that is supplied with electricity during AF. The long axis of left-side third coil 731 coincides with the upper-lower direction. Disposed on left-side third coil placement portion 510 of second base 5, left-side third coil 731 is fixed to left-side FPC 81 by a fixing means such as adhesion.

Left-side third coil 731 is disposed on the left side of left-side third magnet 730 (outside of the left-side third magnet in the width direction). Left-side third coil 731 faces left-side third magnet 730 in the left-right direction, with a predetermined gap being interposed in between. Left-side third coil 731 is connected to right-side third coil 741 and the left-side terminal portion 810 of FPC 8.

In the case of the present embodiment, left-side third magnet 730 is disposed in the movable part, and left-side third coil 731 is disposed in the fixing part. However, left-side third magnet 730 may also be disposed in the fixing part, and left-side third coil 731 may also be disposed in the movable part.

Right-side third driving part 74 is disposed between right wall portion 704 of lens guide 70 and right-side FPC 82 fixed to the right-side surface of right wall portion 52 of second base 5 (outer-side surface in the width direction). Right-side third driving part 74 is also a voice coil motor, and includes right-side third magnet 740 and right-side third coil 741.

Right-side third magnet 740 is disposed on right-side third magnet placement portion 704a of lens guide 70. Right-side third magnet 740 is fixed to right-side third magnet placement portion 704a of lens guide 70 by a fixing means such as adhesion.

Right-side third magnet 740 is composed of two magnet elements adjacent to each other in the front-rear direction. Each of these magnet elements is disposed such that the longitudinal direction coincides with the upper-lower direction. Further, each of these magnet elements is magnetized in the left-right direction, and has one magnetic pole on each side. The directions of the magnetic poles of the magnet elements are opposite to each other.

Right-side third coil 741 is a so-called air-core coil having an oval shape that is supplied with electricity during AF. The long axis of right-side third coil 741 coincides with the upper-lower direction. Disposed on right-side third coil placement portion 520 of second base 5, right-side third coil 741 is fixed to right-side FPC 82 by a fixing means such as adhesion.

Right-side third coil 741 is disposed on the right side of right-side third magnet 740 (outside of the right-side third magnet in the width direction). Right-side third coil 741 faces right-side third magnet 740 in the left-right direction, with a predetermined gap being interposed in between. Right-side third coil 741 is connected to left-side third coil 731 and right-side terminal portion 820 of FPC 8.

In the case of the present embodiment, right-side third magnet 740 is disposed in the movable part, and right-side third coil 741 is disposed in the fixing part. However, right-side third magnet 740 may also be disposed in the fixing part, and right-side third coil 741 may also be disposed in the movable part.

Third position detecting element 75 is fixed to left-side FPC 81 while being disposed at the central portion of left-side third coil 731, as illustrated in FIGS. 4 and 11. Third position detecting element 75 faces left-side third magnet 730 in the left-right direction. Third position detecting element 75 detects a magnetic flux of left-side third magnet 730, and sends a detection value to control part 92 mounted on sensor board 91. Control part 92 determines the position of holder 31 in the direction (front-rear direction) parallel with the second axis based on the detection value received from third position detecting element 75.

In the case of third driving part 72 having the above-described configuration, when a current flows through left-side third coil 731 and right-side third coil 741 via FPC 8 under the control of control part 92, the Lorentz force to displace left-side third magnet 730 and right-side third magnet 740 in the front-rear direction occurs. As a result, lens guide 70 to which left-side third magnet 730 and right-side third magnet 730 are fixed moves in the X direction. At this time, lens guide 70 moves in the X direction while sliding on left-side shaft 710 and right-side shaft 711 of support mechanism 71. Accordingly, autofocus is performed.

Further, lens module 4 according to the present embodiment includes shock absorbing part 76 for absorbing a shock caused when lens guide 70 moves in the front-rear direction to collide with second base 5. Hereinafter, shock absorbing part 76 will be described.

As illustrated in FIGS. 15, 16, 20, and 21, shock absorbing part 76 is composed of left-side first shock absorbing part 76a, left-side second shock absorbing part 76b, right-side first shock absorbing part 76c, and right-side second shock absorbing part 76d disposed at the four corners of lens guide 70.

Left-side first shock absorbing part 76a is disposed on the front end surface of left wall portion 703 of lens guide 70. Left-side second shock absorbing part 76b is disposed on the rear end surface of left wall portion 703 of lens guide 70. Right-side first shock absorbing part 76c is disposed on the front end surface of right wall portion 704 of lens guide 70. Right-side second shock absorbing part 76d is disposed on the rear end surface of right wall portion 704 of lens guide 70.

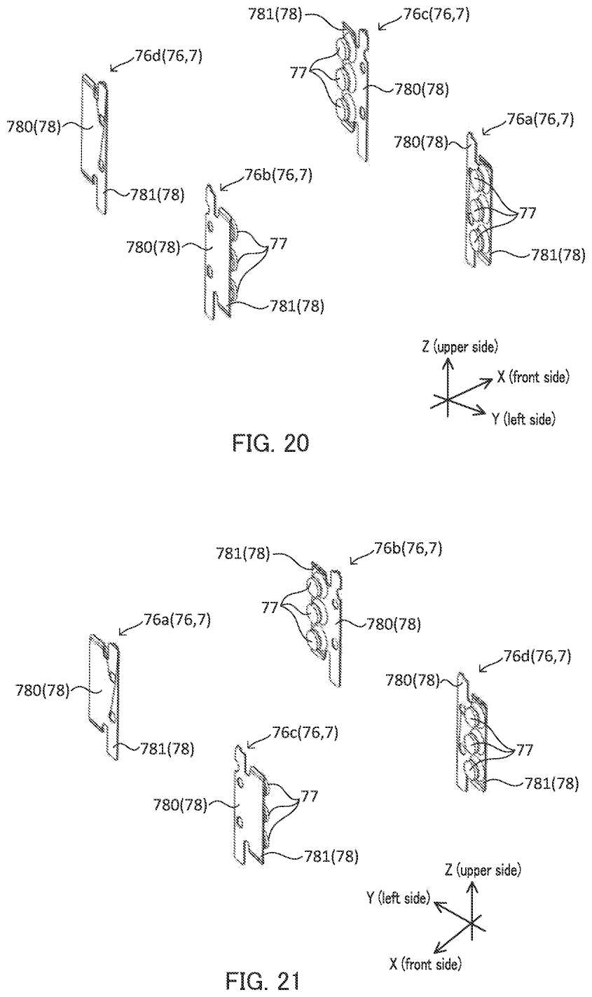

Each of left-side first shock absorbing part 76a, left-side second shock absorbing part 76b, right-side first shock absorbing part 76c, and right-side second shock absorbing part 76d includes damper members 77 and leaf spring 78 as illustrated in FIGS. 20 and 21.

Damper members 77 correspond to one example of a soft part. In the present embodiment, the number of damper members 77 in each of left-side first shock absorbing part 76a, left-side second shock absorbing part 76b, right-side first shock absorbing part 76c, and the number of right-side second shock absorbing part 76d is three. However, the number of damper members 77 is not limited to that in the case of the present embodiment. It is preferable that the material of damper members 77 be a material having elasticity such as an adhesive, a rubber, and a mold material (elastomer), for example.

Damper members 77 at left-side first shock absorbing part 76a are fixed respectively to front-side damper holding portions 703b, 703c, and 703d of left wall portion 703 of lens guide 70.

Damper members 77 at left-side second shock absorbing part 76b are fixed respectively to rear-side damper holding portions 703e, 703f, and 703g of left wall portion 703 of lens guide 70.

Damper members 77 at right-side first shock absorbing part 76c are fixed respectively to front-side damper holding portions 704b, 704c, and 704d of right wall portion 704 of lens guide 70.

Damper members 77 at right-side second shock absorbing part 76d are fixed respectively to rear-side damper holding portions 704e, 704f, and 704g of right wall portion 704 of lens guide 70.

Leaf spring 78 is made of metal, for example, and includes fixation portion 780 and absorbing portion 781. Fixation portion 780 is fixed to a portion of lens guide 70 which does not make contact with second base 5. Absorbing portion 781 covers the surfaces of damper members 77. Absorbing portion 781 is in contact with the surfaces of damper members 77.

Absorbing portion 781 may be adsorbed on the surfaces of damper members 77, or may be fixed to the surfaces of damper members 77 by a fixing means such as an adhesive. Absorbing portion 781 may come into contact with second base 5 at the time of AF. In addition, absorbing portion 781 may come into contact with second base 5 due to, for example, a shock applied to lens guide 70 by dropping or the like. Absorbing portion 781 is elastically deformed to absorb a shock when coming into contact with second base 5.

Specifically, leaf spring 78 of left-side first shock absorbing part 76a is fixed to the front end surface of left wall portion 703 of lens guide 70. More specifically, fixation portion 780 of leaf spring 78 in left-side first shock absorbing part 76a is fixed to front-side leaf-spring fixation portion 703h of left wall portion 703 of lens guide 70. Further, absorbing portion 781 of leaf spring 78 in left-side first shock absorbing part 76a covers the surfaces (front-side surfaces) of damper members 77 in left-side first shock absorbing part 76a. Absorbing portion 781 of leaf spring 78 in left-side first shock absorbing part 76a faces front-side stopper portion 511 of left wall portion 51 of second base 5 (see FIG. 4) in the front-rear direction.

Leaf spring 78 of left-side second shock absorbing part 76b is fixed to the rear end surface of left wall portion 703 of lens guide 70. Specifically, fixation portion 780 of leaf spring 78 in left-side second shock absorbing part 76b is fixed to rear-side leaf-spring fixation portion 703i of left wall portion 703 of lens guide 70. Further, absorbing portion 781 of leaf spring 78 in left-side second shock absorbing part 76b covers the surfaces (rear-side surfaces) of damper members 77 in left-side second shock absorbing part 76b. Absorbing portion 781 of leaf spring 78 in left-side second shock absorbing part 76b faces rear-side stopper portion 512 of left wall portion 51 of second base 5 (see FIG. 4) in the front-rear direction.

Leaf spring 78 of right-side first shock absorbing part 76c is fixed to the front end surface of right wall portion 704 of lens guide 70. Specifically, fixation portion 780 of leaf spring 78 in right-side first shock absorbing part 76c is fixed to front-side leaf-spring fixation portion 704h of right wall portion 704 of lens guide 70. Further, absorbing portion 781 of leaf spring 78 in right-side first shock absorbing part 76c covers the surfaces (front-side surfaces) of damper members 77 in right-side first shock absorbing part 76c. Absorbing portion 781 of leaf spring 78 in right-side first shock absorbing part 76c faces front-side stopper portion 521 of right wall portion 52 of second base 5 (see FIG. 3) in the front-rear direction.

Leaf spring 78 of right-side second shock absorbing part 76d is fixed to the rear end surface of right wall portion 704 of lens guide 70. Specifically, fixation portion 780 of leaf spring 78 at right-side second shock absorbing part 76d is fixed to rear-side leaf-spring fixation portion 704i of right wall portion 704 of lens guide 70. Further, absorbing portion 781 of leaf spring 78 in right-side second shock absorbing part 76d covers the surfaces (rear-side surfaces) of damper members 77 in right-side second shock absorbing part 76d. Absorbing portion 781 of leaf spring 78 in right-side second shock absorbing part 76d faces rear-side stopper portion 522 of right wall portion 52 of second base 5 (see FIG. 3) in the front-rear direction.

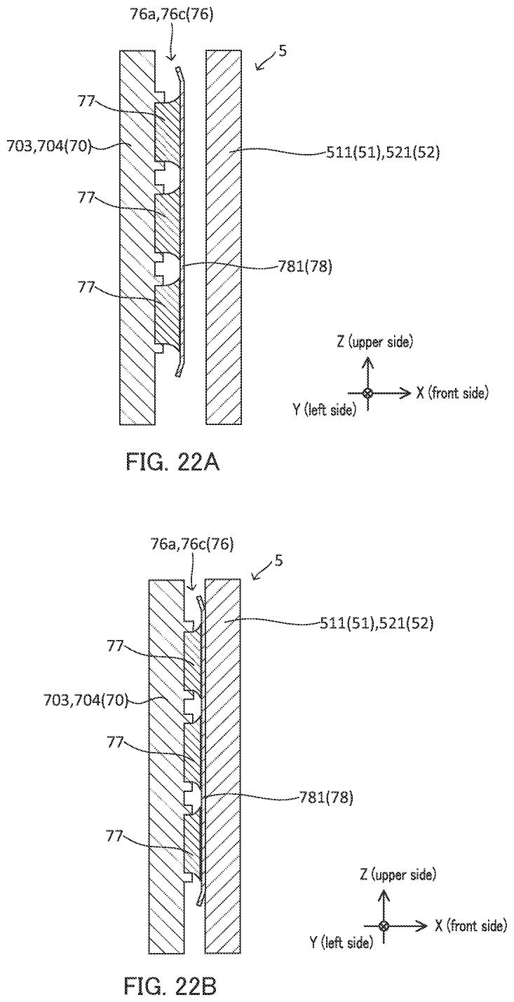

Shock absorbing part 76 having the above configuration absorbs a shock caused when lens guide 70 moves in the front-rear direction to collide with second base 5. FIGS. 22A and 22B are sectional views of portions corresponding to left-side first shock absorbing part 76a and right-side first shock absorbing part 76c.

FIG. 22A is a diagram corresponding to a state in which lens guide 70 has not moved in the front-rear direction (hereinafter, referred to as a reference state of lens guide 70). FIG. 22B is a diagram corresponding to a state in which lens guide 70 has moved forward by a predetermined distance from the reference state.

In the reference state of lens guide 70, there is a gap in the front-rear direction between absorbing portion 781 of leaf spring 78 in left-side first shock absorbing part 76a and front-side stopper portion 511 of left wall portion 51 of second base 5 as illustrated in FIG. 22A.

In the reference state of lens guide 70, there is a gap in the front-rear direction between absorbing portion 781 of leaf spring 78 in right-side first shock absorbing part 76c and front-side stopper portion 521 of right wall portion 52 of second base 5 as illustrated in FIG. 22A.

When lens guide 70 moves forward from the reference state by a predetermined distance, absorbing portion 781 of leaf spring 78 in left-side first shock absorbing part 76a comes into contact with front-side stopper portion 511 of left wall portion 51 of second base 5, and absorbing portion 781 of leaf spring 78 in right-side first shock absorbing part 76c collides with front-side stopper portion 521 of right wall portion 52 of second base 5 as illustrated in FIG. 22B.

During such a collision, absorbing portion 781 of leaf spring 78 in left-side first shock absorbing part 76a and absorbing portion 781 of leaf spring 78 in right-side first shock absorbing part 76c are elastically deformed. Additionally, damper members 77 of left-side first shock absorbing part 76a and damper members 77 of right-side first shock absorbing part 76c are elastically deformed. Accordingly, the shock associated with the collision is absorbed.

Meanwhile, although not illustrated, when lens guide 70 moves rearward by a predetermined distance, absorbing portion 781 of leaf spring 78 in left-side second shock absorbing part 76b comes into contact with rear-side stopper portion 512 of left wall portion 51 of second base 5, and absorbing portion 781 of leaf spring 78 in right-side second shock absorbing part 76d collides with rear-side stopper portion 522 of right wall portion 52 of second base 5.

During such a collision, absorbing portion 781 of leaf spring 78 in left-side second shock absorbing part 76b and absorbing portion 781 of leaf spring 78 in right-side second shock absorbing part 76d are elastically deformed. Additionally, damper members 77 of left-side second shock absorbing part 76b and damper members 77 of right-side second shock absorbing part 76d are elastically deformed. Accordingly, the shock associated with the collision is absorbed.

In the case of lens module 4 described above, when a current flows through left-side third coil 731 and right-side third coil 741 of AF device 7 via FPC 8, the Lorentz force to displace left-side third coil 731 and right-side third coil 741 in the direction of the optical axis (X direction) occurs.

Then, since left-side third coil 731 and right-side third coil 741 are fixed to lens guide 70, lens guide 70 moves in the direction of the optical axis (X direction) based on the Lorentz force. Note that, by controlling the directions of the current flowing through left-side third coil 731 and right-side third coil 741, the moving direction (rotational direction) of lens guide 70 is switched. Thus, autofocus is performed.

In the case of camera module 1 according to the present embodiment having the above-described configuration, it is possible to reduce the size of the product. The reason for this will be described with reference to FIG. 8B. To begin with, when swing center C1 of prism 22 is disposed on the lower surface of holder 31 as in the conventional structure, the distance from swing center C1 to corner portion P1 situated on the upper surface of prism 22 and being the farthest position from swing center C1 is R1. Therefore, when prism 22 is swung about an axis that passes through swing center C1 and that is parallel to the left-right direction (Y direction), the radius of rotation of corner portion P1 is R1.

In contrast, in the case of the present embodiment, swing center C2 of prism 22 is the center of ball 321. When swing center C2 is disposed near the center of mounting surface 310 of holder 31, the distance from swing center C2 to corner portion P1 is R2. Therefore, when prism 22 is swung about an axis that passes through swing center C2 and that is parallel to the left-right direction (Y direction), the radius of rotation of corner portion P1 is R2. As illustrated in FIG. 8B, radius of rotation R2 is smaller than radius of rotation R1. Therefore, when the swing angle of prism 22 is the same, the movement distance of corner portion P1 according to camera module 1 of the present embodiment is shorter than the movement distance of corner portion P1 according to the camera module of the conventional structure. When the movement distance of corner portion P1 is large, there is a possibility that the product size is increased since a member to be disposed around corner portion P1 is disposed to avoid the movement locus of corner portion P1. On the other hand, in the case of the present embodiment, the movement distance of corner portion P1 is small. Thus, the member to be disposed around corner portion P1 can be disposed relatively close to corner portion P1. As a result, reduction of the product size can be achieved.

Further, in the case of camera module 1 according to the present embodiment, lens module 4 includes above-described shock absorbing part 76. As described above, shock absorbing part 76 absorbs a shock caused when lens guide 70 collides with second base 5. In particular, in the present embodiment, at the time of the aforementioned collision, absorbing portions 781 of leaf springs 78 in shock absorbing part 76 collide with second base 5 as illustrated in FIG. 22B. Each of leaf springs 78 is made of a metal material having a relatively high hardness. Therefore, it is possible to improve the durability of shock absorbing part 76 as compared with the case where damper members 77 come into direct contact with second base 5. As a result, damage to shock absorbing part 76 can be suppressed.

Further, in the case of camera module 1 according to the present embodiment, lens guide 70 is supported on second base 5 by left-side shaft 710 and right-side shaft 711. Such a support mechanism is more durable than a configuration in which the lens guide is supported by a ball. Further, such a configuration can support the lens guide more stably as compared with the configuration of supporting the lens guide by the ball.

Further, left-side shaft 710 is in contact, at each of the two places in the axial direction (front-rear direction), with left-side second supporting portions 701a and 701b of lens guide 70 at the two places in the width direction. On the other hand, right-side shaft 711 is in contact, at one place in the axial direction (front-rear direction), with right-side second supporting portion 702a of lens guide 70 at one place in the width direction. Such a configuration makes it possible to suppress inclination of lens guide 70 that might be caused in an assembled state due to the influence of variations in the dimensions of lens guide 70. As a result, the posture of lens guide 70 with respect to second base 5 is stabilized.

(Additional Remarks)

While the present invention has been specifically described based on the embodiment, it is not intended to limit the present invention to the above-mentioned preferred embodiment, but the present invention may be further modified within the scope and spirit of the invention defined by the appended claims.

While smartphone M (see FIGS. 23A and 23B) serving as a camera-equipped mobile terminal has been described in the embodiment as one example of the camera-mounted device including camera module 1, the present invention is applicable to a camera-mounted device including a camera module and an image processing part that processes image information obtained by the camera module. The camera-mounted device encompasses an information apparatus and a transporting apparatus. Examples of the information apparatus include a camera-mounted mobile phone, a note-type personal computer, a tablet terminal, a mobile game machine, a web camera, and a camera-mounted in-vehicle device (for example, a rear-view monitor device or a drive recorder device). In addition, examples of the transporting apparatus include an automobile.

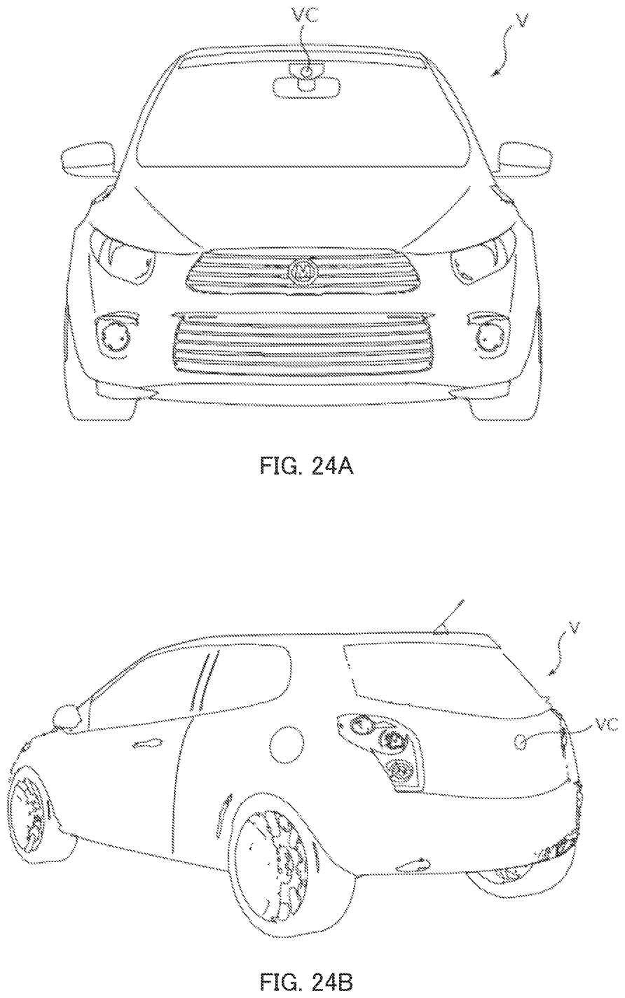

FIGS. 24A and 24B illustrate automobile V serving as the camera-mounted device in which in-vehicle camera module VC (Vehicle Camera) is mounted. FIG. 24A is a front view of automobile V and FIG. 24B is a rear perspective view of automobile V. In automobile V, camera module 1 described in the embodiment is mounted as in-vehicle camera module VC. As illustrated in FIGS. 24A and 24B, in-vehicle camera module VC may, for example, be attached to the windshield so as to face forward, or to the rear gate so as to face backward. In-vehicle camera module VC is used for rear monitoring, drive recording, collision avoidance control, automatic drive control, and the like.

### INDUSTRIAL APPLICABILITY

The optical actuator and the camera module according to the present invention can be mounted on a thin camera-mounted device such as, for example, a smartphone, a mobile phone, a digital camera, a notebook personal computer, a tablet terminal, a portable game machine, an in-vehicle camera.

### REFERENCE SIGNS LIST

1 Camera modules
2 Optical path bending module
21 First base
210 First base main body
211 Bottom wall portion
211a second coil placement portion
212 Left wall portion
212a Left-side first coil placement portion
213 Right wall portion
213a Right-side first coil placement portion
214 Supporting wall portion
214a rear wall portion
214b supporting portion
214c protruding-portion-side tapered surface
22 Prism
3 Optical image stabilization device
31 Holder
310 Mounting surface
311 Left-side first magnet placement portion
312 Right-side first magnet placement portion
313 Second magnet placement portion
314 Recessed portion
314a Recessed-portion-side tapered surface
314b Spring fixation portion
314c Locking protruding portion
32 Swing supporting portion
321 Ball
322 Biasing spring
323 Outer fixation portion
323a Left-side fixation portion
323b Right-side fixation portion
324 Inner fixation portion
324a Central hole
324b Locking hole
325 Connecting portion
325a, 325b Left-side connecting portion
325c, 325d Right-side connecting portion
33 First driving part
34 Left-side first driving part
340 Left-side first magnet
341 Left-side first coil
35 Right-side first driving part
350 Right-side first magnet
351 Right-side first coil
36 First position detecting element
37 Second driving part
370 Second magnet
371 Second coil
372 Second position detecting element
4 Lens Module
5 Second base
50 Bottom wall portion
500 Left-side groove portion
500a, 500b Left-side first supporting portion
500c, 500d Tapered support surface
501 Right-side groove portion
501a, 501b Right-side first supporting portion
501c, 501d Tapered support surface
502 Left-side yoke
503 Right-side yoke
51 Left wall portion
510 Left-side third coil placement portion
511 Front-side stopper portion
512 Rear-side stopper portion
52 Right wall portion
520 Right-side third coil placement portion
521 Front-side stopper portion
522 Rear-side stopper portion
53 Front wall portion
6 Lens part
7 AF device
70 Lens guide
700 Bottom side wall
701 Left-side groove portion
701a, 701b Left-side second supporting portion
701c, 701d Tapered support surface
702 Right-side groove portion
702a Right-side second supporting portion
702b Support surface
702c Front-side stopper portion
702d Rear-side stopper portion
703 Left wall portion
703a Left-side third magnet placement portion
703b, 703c, 703d Front-side damper holding portion
703e, 703f, 703g Rear-side damper holding portion
703h Front-side leaf-spring fixation portion
703i Rear-side leaf-spring fixation portion
704 Right wall portion
704a Right-side third magnet placement portion
704b, 704c, 704d Front-side damper holding portion
704e, 704f, 704g Rear-side damper holding portion
704h Front-side leaf-spring fixation portion
704i Rear-side leaf-spring fixation portion
71 Support mechanism
710 Left-side shaft
711 Right-side shaft
72 Third driving part
73 Left-side third driving part
730 Left-side third magnet
731 Left-side third coil
74 Right-side third driving part
740 Right-side third magnet
741 Right-side third coil
75 Third position detecting element
76 Shock absorbing part
76a Left-side first shock absorbing part
76b Left-side second shock absorbing part
76c Right-side first shock absorbing part
76d Right-side second shock absorbing part
77 Damper member
78 Leaf spring
780 Fixing part
781 Absorbing part
8 FPC
81 Left-side FPC
810 Left-side terminal portion
82 Right-side FPC
820 Right-side terminal portion
83 Lower-side FPC
9 Image capturing device module
90 Image capturing device
91 Sensor board
92 Control part
93 Cover

1. An optical actuator, comprising:
a movable part including a mounting surface for an optical path bending member, and a recessed portion extending toward a center of the mounting surface at a back side of the mounting surface, the movable part being swung by driving of a driving part; and
a fixing part including a protruding portion inserted into the recessed portion so as to define a swing center of the movable part as a position near the center of the mounting surface.

2. The optical actuator according to claim 1, wherein:
the protruding portion supports the movable part via a ball disposed between the protruding portion and the recessed portion, the ball serving as the swing center, and
each of the protruding portion and the recessed portion includes a tapered surface making annular contact with a spherical surface of the ball.

3. The optical actuator according to claim 2, wherein:
the protruding portion includes a protruding-portion-side tapered surface making contact with the ball, and
the recessed portion includes a recessed-portion-side tapered surface making contact with the ball and having a taper angle smaller than a taper angle of the protruding-portion-side tapered surface.

4. The optical actuator according to claim 1, wherein
the fixing part further includes a biasing member that biases the movable part toward the protruding portion.

5. The optical actuator according to claim 4, wherein:
the fixing part includes a fixing-part main body and a supporting wall portion, the supporting wall portion being formed separately from the fixing-part main body and including an inner surface on which the protruding portion is formed, and
the biasing member includes a first fixing part fixed to the fixing-part main body and a second fixing part fixed to the movable part.

6. The optical actuator according to claim 1, wherein:
the optical path bending member refracts incident light parallel to a first direction in a second direction perpendicular to the first direction, and
each of the recessed portion and the protruding portion extends in the second direction.

7. The optical actuator according to claim 6, wherein:
the driving part is disposed between a lower surface of the movable part and a bottom wall portion of the fixing part, and
the swing center and the driving part are disposed on a same straight line parallel to the first direction.

8. A camera module, comprising:
an optical actuator according to claim 1; and
an image capturing device disposed downstream of the optical actuator.

9. A camera-mounted device, comprising:
a camera module according to claim 8; and
a control part for controlling the camera module.
